(19) United States
(12) Patent Application Publication
(10) Pub. No.: US 2008/0259281 A1
(43) Pub. Date: Oct. 23, 2008

(54) Apparatus and method for displaying three-dimensional image

(75) Inventors: Ryota Odake, Tokyo (JP); Masatake Hayashi, Kanagawa (JP); Shuuji Moro, Tokyo (JP); Junichi Ohsako, Tokyo (JP); Hisataka Izawa, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/977,309

(22) Filed: Oct. 24, 2007

(30) Foreign Application Priority Data
Oct. 26, 2006 (JP) JP2006-290616

(51) Int. Cl. G03B 21/14

(52) U.S. Cl. 353/7

(57) ABSTRACT

A three-dimensional-image display apparatus includes a projecting unit having a projection plane and a plurality of projecting elements for projecting images having parallax therebetween through the projection plane; a display for displaying a three-dimensional image by receiving the images projected from the plurality of projecting elements; and a common lens for guiding rays of the images to the display, the common lens being arranged between the projection plane and the display and having a focal length larger than a distance between the projection plane and the display.

### CROSS REFERENCES TO RELATED APPLICATIONS

The present invention contains subject matter related to Japanese Patent Application JP 2006-290616 filed in the Japanese Patent Office on Oct. 26, 2006, the entire contents of which are incorporated herein by reference.

### BACKGROUND OF THE INVENTION

1. Field of the Invention

The present invention relates to an apparatus and method for displaying a three-dimensional image, the apparatus employing a multi-view system in which a plurality of image generators is used.

2. Description of the Related Art

Japanese Patent No. 3576521 (paragraph [0047] and FIG. 3(b)) discloses an apparatus for generating a three-dimensional image in which a plurality of image generators projects images having parallax therebetween. Because a human observes an image emitted from a diffusion plate with the horizontally aligned left and right eyes, horizontal parallax occurs. In the above apparatus, horizontally aligned image generators generate images viewed from different horizontal angles, i.e., images having parallax therebetween. A three-dimensional image is displayed by synthesizing such images.

The apparatus of Japanese Patent No. 3576521 employs an afocal optical system in which light rays projected from a plurality of image generators are made parallel to each other. The afocal optical system includes a microlens array, which is provided to correspond to the plurality of image generators arranged two-dimensionally, and one common lens, for example. By employing an afocal optical system, pencils of light rays projected from the image generators are projected on the same area of the diffusion plate (the vertical diffusion plate) serving as a screen. In general, in a multi-view system, a three-dimensional image is displayed on an area of a screen where images overlap each other. The above apparatus uses the afocal optical system to maximally reduce the projection distance between the image generators and the diffusion plate so as to maximally increase the image-overlapping area on the diffusion plate.

### SUMMARY OF THE INVENTION

However, the apparatus of Japanese Patent No. 3576521 has to have a projection distance larger than at least the focal length of the common lens. In order to make a compact display apparatus, further improvements are necessary.

In view of the above, a technique for making a compact three-dimensional-image display apparatus employing a common lens is preferably provided.

According to an embodiment of the present invention, there is provided a three-dimensional-image display apparatus that includes a projecting unit having a projection plane and a plurality of projecting elements for projecting images having parallax therebetween through the projection plane; a display for displaying a three-dimensional image by receiving the images projected from the plurality of projecting elements; and a common lens for guiding rays of the images to the display, the common lens being arranged between the projection plane and the display and having a focal length larger than a distance between the projection plane and the display.

In the apparatus according to the embodiment of the invention, the focal length of the common lens is larger than the distance between the projection plane and the display. This leads to reduction in distance between the projection plane and the display. Accordingly, a compact three-dimensional-image display apparatus can be provided.

Use of a Fresnel lens as the common lens may be especially advantageous to the invention. Light passing through the periphery of a Fresnel lens with a shorter focal length has a larger aberration and a lower luminance. However, unlike the apparatus of Japanese Patent No. 3576521, the focal length of the common lens is not necessarily the same as the distance between the projection plane and the display. Therefore, the aberration can be reduced and the luminance can be increased. That is, the apparatus can be made smaller without degrading image quality, compared to that of Japanese Patent No. 3576521. Moreover, the thinness of the Fresnel lens contributes to thinning of the three-dimensional-image display apparatus.

According to an embodiment of the present invention, there is provided a method for displaying a three-dimensional image. The method includes the steps of projecting a plurality of images having parallax therebetween through a projection plane; guiding rays of the images projected through the projection plane to a display using a common lens arranged between the projection plane and the display, the common lens having a focal length larger than a distance between the projection plane and the display; and displaying a three-dimensional image on the display by receiving the rays emitted from the common lens.

As described above, according to the embodiments of the invention, a compact three-dimensional-image display apparatus employing a common lens can be provided. Further, the luminance uniformity of a three-dimensional image can be improved.

### BRIEF DESCRIPTION OF THE DRAWINGS

FIGS. 1A and 1B show the difference between a two-dimensional image and a three-dimensional image;

FIG. 2 shows the principle of the multi-view system as a method for realizing a three-dimensional image;

FIG. 3 schematically shows an image display apparatus employing the multi-view system shown in FIG. 2;

FIG. 4 schematically shows an exemplary image display apparatus including a single common lens behind a screen;

FIG. 5 schematically shows a three-dimensional-image display apparatus according to an embodiment of the present invention; and

FIG. 6 schematically shows a three-dimensional-image display apparatus according to another embodiment of the present invention.

### DESCRIPTION OF THE PREFERRED EMBODIMENTS

Embodiments of the invention will now be described with reference to the drawings.

Before describing a three-dimensional image display apparatus according to an embodiment, the principle of a three-dimensional image display will be described.

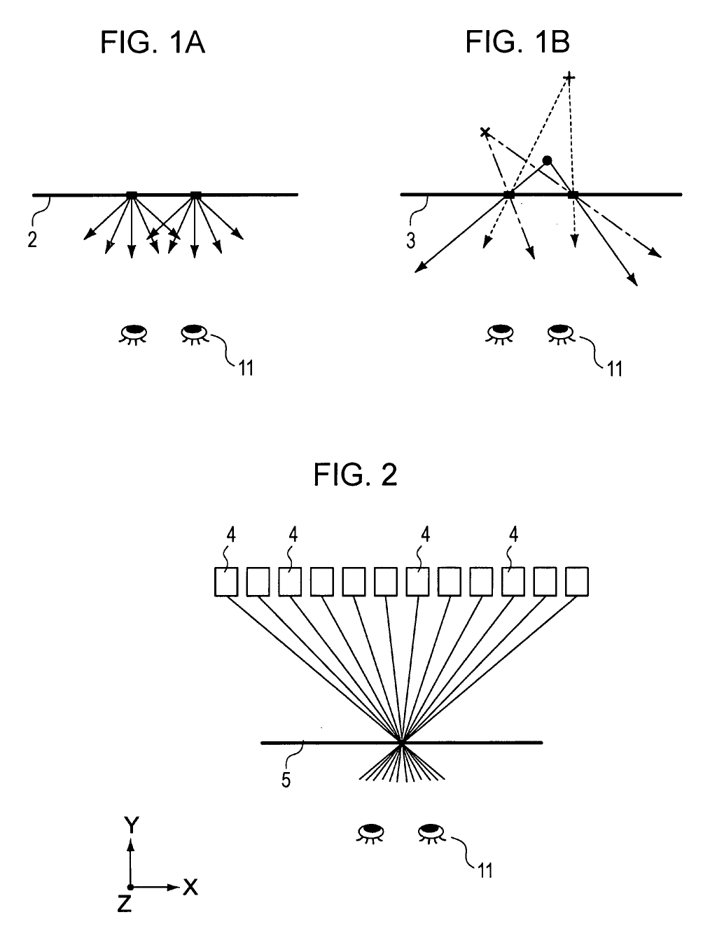

FIGS. 1A and 1B show the difference between a two-dimensional image and a three-dimensional image. As shown in FIG. 1A, a screen 2 of a typical two-dimensional display has a diffusing surface that diffuses light rays of an equal luminous intensity in all directions. In contrast, as shown in FIG. 1B, a screen 3 of a three-dimensional display has a function to diffuse light rays of different luminous intensities depending on the direction. Therefore, when an observer 11 views a three-dimensional display from different angles, the observer 11 can view different images through the left and right eyes. The parallax occurring at this time allows the observer 11 to view a three-dimensional image.

One method for realizing a three-dimensional image is the use of a multi-view system. FIG. 2 shows the principle of a multi-view system. For example, a plurality of projectors 4 that serves as projecting elements is arranged in a horizontal (X direction) row. The projectors 4 project images having parallax therebetween on a screen 5. Such images can be obtained by taking images of an object using a plurality of cameras.

The screen 5 has a larger diffusing power in the vertical direction (Z direction) than in the horizontal direction (X direction). For example, the horizontal diffusion angle (for example, the divergence angle of a pencil of an image ray emitted from one of the projectors 4) is only a degree or so, and the vertical diffusion angle is several tens of degrees. The screen 5 may be, for example, a lenticular sheet, a hologram sheet, or the like.

The screen is not limited to the above-described screen 5. For example, if the projectors 4 are arranged two-dimensionally, i.e., in the horizontal and vertical directions, diffusion angles in the horizontal and vertical directions may be substantially the same. The projectors 4 in the two-dimensional arrangement project images with parallax in both horizontal and vertical directions.

When a number of the projectors 4 are arranged two-dimensionally as shown in FIG. 2, a three-dimensional image can be realized on the basis of the so-called ray-reproduction method. If the ray-reproduction method is employed, the screen 5 may not be necessary. In the ray-reproduction method, images taken with a plurality of cameras so as to produce the effect of parallax are processed and synthesized into a single three-dimensional image. This image processing is performed in accordance with, for example, parallax angles and associated refractive indices and the like.

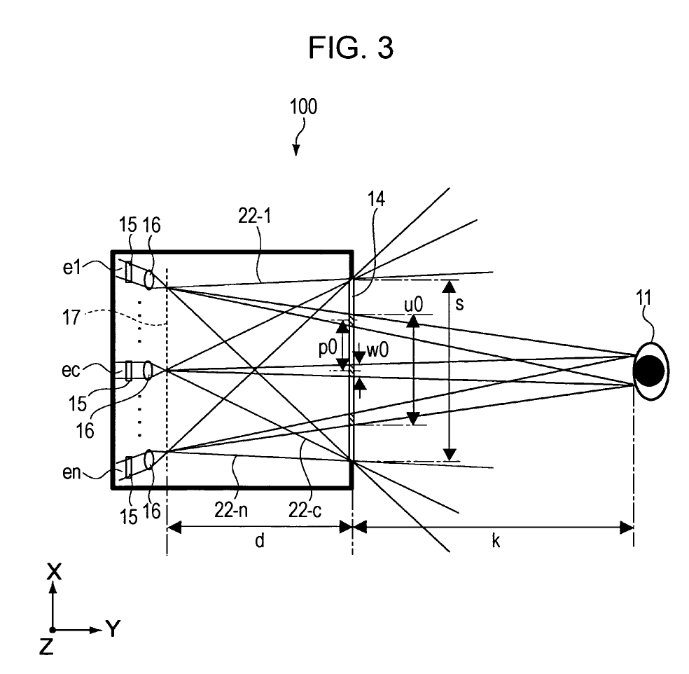

FIG. 3 is a schematic diagram of an image display apparatus employing the multi-view system shown in FIG. 2 and is a top view of the image display apparatus. An image display apparatus 100 includes a plurality of projectors (n number of projectors) e1, . . . , ec, . . . , and en that are disposed in a horizontal row, and a screen 14 on which images projected from the projectors e1 to en are displayed. For easier understanding, FIG. 3 only shows representative projectors among the n number of projectors e1 to en, i.e., the projectors e1 and en at both ends and the projector ec near the center. In this example, the projectors e1 to en are lined up in the horizontal direction (X direction), and the screen 14 has a larger diffusing power in the vertical direction (Z direction) but a smaller diffusing power in the horizontal direction as described above.

Each of the projectors e1 to en includes an optical modulator 15, such as a liquid crystal panel or a digital micro-mirror device (DMD), and a lens system 16 that enlarges and projects an image displayed by the optical modulator 15. Each of the projectors e1 to en also includes a light source (not shown). The projectors e1, ec, and en respectively emit image rays 22-1, 22-c, and 22-n that become inverted at a projection plane 17. The screen 14 is disposed at a distance d from the projection plane 17. In each of the projectors e1 to en shown in FIG. 3, the optical modulator 15 and the lens system 16 are disposed at positions shifted from each other, i.e., disposed with an offset, in the horizontal direction (X direction). This causes the image rays 22-1 to 22-n emitted from the projectors e1 to en to have as large an overlapping area as possible on the screen 14.

In the image display apparatus 100 shown in FIG. 3, respective images of the projectors e1, ec, and en are observed by one eye of an observer 11 as a sub-image with a constant width w0 composed of several pixels. The image rays 22-1, 22-c, and 22-n from the three projectors e1, ec, and en are diffused by the screen 14 at a very narrow angle in the X direction and at a wide angle in the Z direction. Accordingly, three vertically long sub-images each having a width of w0 and a pitch of p0 are observed. When the actual number of projectors e1 to en is defined as n, n vertically long sub-images are projected closely adjoining each other. Therefore, the sub-images are practically recognized as a single image. This single image observed by the eye has a width of u0. The width u0 becomes wider as an observation distance k becomes larger. However, the width u0 is necessarily narrower than a screen width s unless the distance k becomes an infinite value. Hence, a three-dimensional image occupying the entire area of the screen 14 may not practically be observed. This means that, when the projectors e1 to en are arranged with a total width (X-direction width) substantially the same as that of the screen 14, the observer 11 can only view a three-dimensional image within a partial central region of the screen 14.

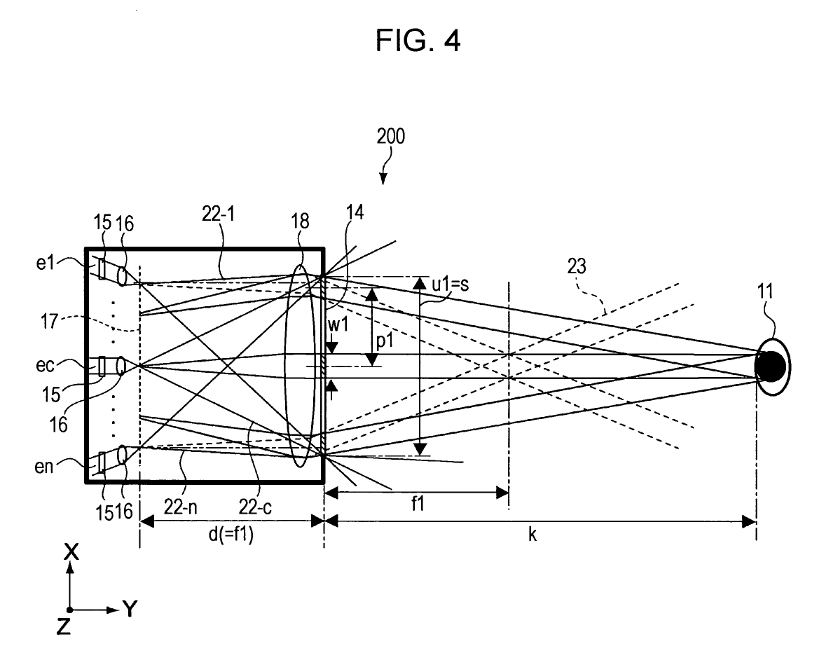

In order to solve such a problem, referring to FIG. 4, an image display apparatus 200 includes a common lens 18 provided between the screen 14 and the projectors e1 to en and immediately behind the screen 14. This configuration is, in principle, similar to that of the apparatus disclosed in Japanese Patent No. 3576521. An observer-side focal length f1 of the common lens 18 is equivalent to the distance d from the projection plane 17 to the screen 14, whereby the lens system 16 and the common lens 18 constitute an afocal optical system. That is, a group of the image rays 22-1, 22-c, and 22-n oriented in parallel from the projection plane 17 are displayed on the screen 14. Accordingly, the observer 11 can view a three-dimensional image with a width u1 that is substantially the same as that of the projection plane 17. In FIG. 4, a ray 23 indicated by dotted lines is illustrated so as to depict the focal length f1 of the common lens 18, and the width u1 of the entire image viewed by the eye of the observer 11 is the same as the screen width s when the observation distance k is larger than the distance d, i.e., f1.

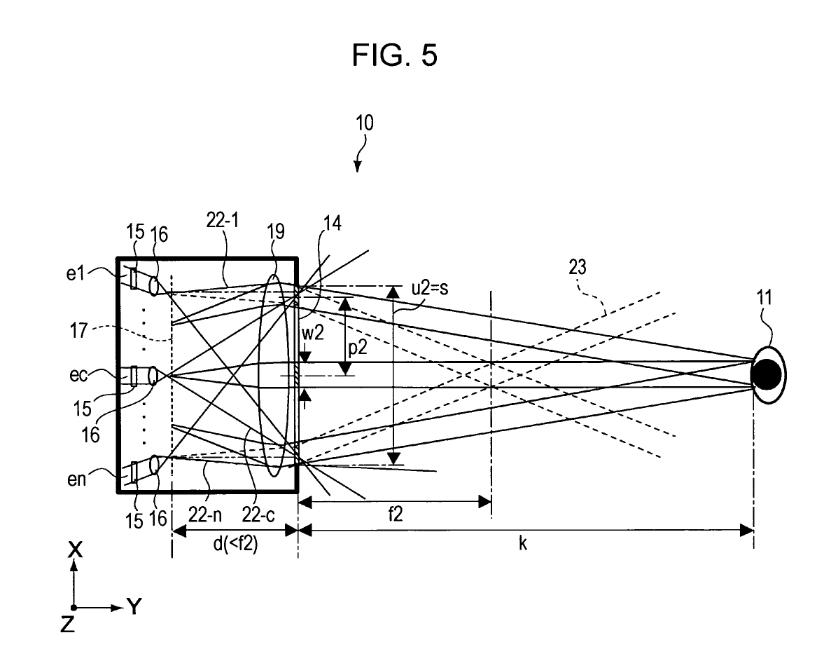

FIG. 5 is a schematic diagram of a three-dimensional-image display apparatus according to an embodiment of the present invention. A three-dimensional-image display apparatus 10 includes the projectors e1 to en disposed in a horizontal line, the screen 14 serving as a display, and a common lens 19 provided between the screen 14 and the projectors e1 to en for guiding the respective image rays 22-1 to 22-n emitted from the projectors e1 to en to the screen 14. FIG. 5 shows projectors similar to those shown in FIGS. 3 and 4 each including the optical modulator 15 and the lens system 16 disposed with an offset. However, projectors each including the optical modulator 15 and the lens system 16 disposed without an offset may also be employed.

The three-dimensional-image display apparatus 10 according to this embodiment differs from the image display apparatus 200 shown in FIG. 4 in including a common lens 19 having a focal length f2 (refer to a ray 23 indicated by dotted lines) larger than the distance from the projection plane 17 to the screen 14. This can reduce the distance d between the projection plane 17 and the screen 14, thereby making the three-dimensional-image display apparatus 10 thinner or smaller. The common lens 19 may be any lens as long as it has refractivity for condensing light.

After being emitted from the projectors e1 to en and then passing through the common lens 19, each of the image rays 22-1 to 22-n has a width w2 and reaches the eye of the observer 11. If the common lens 18 shown in FIG. 4 and the common lens 19 are the same lens, the incident angles of the image rays 22-1 and 22-n with respect to the common lens 19 shown in FIG. 5 are larger than those with respect to the common lens 18 shown in FIG. 4, in accordance with the above-described relationship of d<f2. Accordingly, w2 is wider than w1. If the observation distance k is larger than the distance d, a width u2 of the entire image viewed by the eye of the observer 11 is the same as the screen width s. For example, the distance d can be set to about two to three times the value of f2, but is not limited thereto, of course.

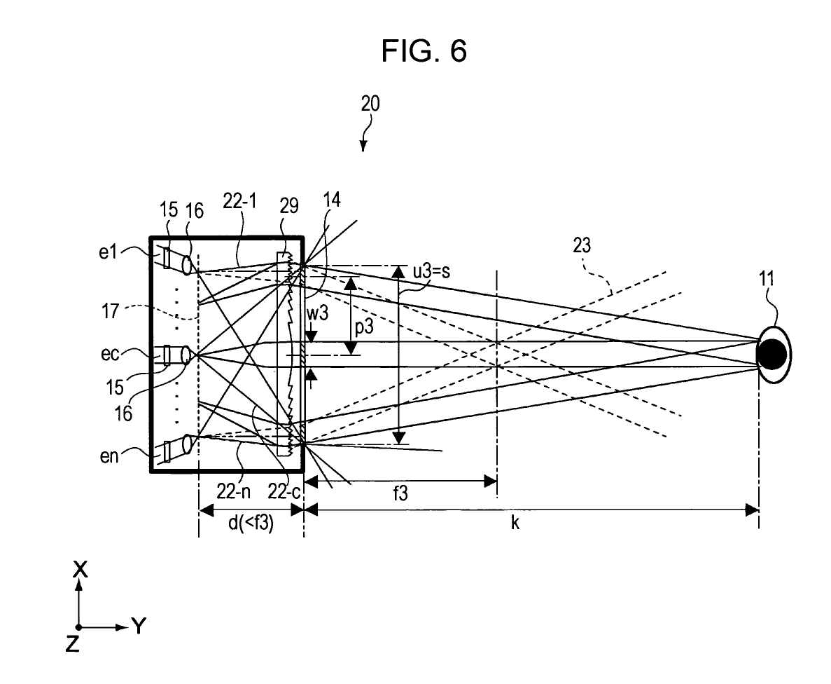

FIG. 6 is a schematic diagram of a three-dimensional-image display apparatus according to another embodiment of the present invention. A three-dimensional-image display apparatus 20 according to this embodiment employs a Fresnel lens 29 as the common lens. Also in this embodiment, a focal length f3 of the Fresnel lens 29 is set larger than the distance d from the projection plane 17 to the screen 14. In general, a Fresnel lens with a smaller focal length has a larger aberration and a lower luminance at the peripheral portion of the Fresnel lens. In this embodiment, however, since the focal length f3 of the Fresnel lens 29 is not necessarily reduced in accordance with the distance from the projection plane 17 to the screen 14, the aberration can be reduced and the luminance can be increased. That is, the apparatus can be made smaller than that of Japanese Patent No. 3576521 without degrading image quality. Moreover, the thinness of the Fresnel lens 29 contributes to thinning of the three-dimensional-image display apparatus 20.

It should be understood by those skilled in the art that various modifications, combinations, sub-combinations and alterations may occur depending on design requirements and other factors insofar as they are within the scope of the appended claims or the equivalents thereof.

1. A three-dimensional-image display apparatus comprising:
a projecting unit having a projection plane and a plurality of projecting elements for projecting images having parallax therebetween through the projection plane;
a display for displaying a three-dimensional image by receiving the images projected from the plurality of projecting elements; and
a common lens for guiding rays of the images to the display, the common lens being arranged between the projection plane and the display and having a focal length larger than a distance between the projection plane and the display.

2. The three-dimensional-image display apparatus according to claim 1, wherein the common lens is a Fresnel lens.

3. A method for displaying a three-dimensional image, the method comprising the steps of:
projecting a plurality of images having parallax therebetween through a projection plane;
guiding rays of the images projected through the projection plane to a display using a common lens arranged between the projection plane and the display, the common lens having a focal length larger than a distance between the projection plane and the display; and
displaying the three-dimensional image on the display by receiving the rays emitted from the common lens.

4. The method according to claim 3, wherein the common lens is a Fresnel lens.

5. A three-dimensional-image display apparatus comprising:
first projecting means having a projection plane and a plurality of second projecting means for projecting images having parallax therebetween through the projection plane;
display means for displaying a three-dimensional image by receiving the images projected from the plurality of second projecting means; and
a common lens for guiding rays of the images to the display means, the common lens being arranged between the projection plane and the display means and having a focal length larger than a distance between the projection plane and the display means.

6. The three-dimensional-image display apparatus according to claim 5, wherein the common lens is a Fresnel lens.
